(19) United States
(12) Patent Application Publication
(10) Pub. No.: US 2022/0121763 A1
(43) Pub. Date: Apr. 21, 2022

(54) Method and Apparatus for Device Lock Control

(71) Applicant: Schok, LLC, Frisco, TX (US)

(72) Inventor: Samuel Gutierrez Carranza, Frisco, TX (US)

(21) Appl. No.: 17/500,601

(22) Filed: Oct. 13, 2021

Related U.S. Application Data
(60) Provisional application No. 63/094,754, filed on Oct. 21, 2020.

(51) Int. Cl. G06F 21/62; G06F 21/31; G06F 21/45; G06F 21/51; G06F 21/82

(52) U.S. Cl. CPC G06F 21/629; G06F 21/31; G06F 21/45; G06F 2221/2149; G06F 21/82; G06F 2221/2141; G06F 2221/032; G06F 21/51

(57) ABSTRACT

A method for implementing lock control of hardware and software features in a device comprises authorizing, using a menu displayed on the device, a customer for implementing lock control on the device for a group of users, blocking the group of users from accessing each system feature switched off by the customer, and blocking the group of users from accessing each application switched off by the customer. The device is a mobile device, such as a mobile phone, a smartphone, or a tablet.

This application claims priority to U.S. Patent Application No. 63/094,754, filed Oct. 21, 2020 by Samuel Gutierrez Carranza, and entitled “Schok Lock Control,” which is incorporated herein by reference in its entirety.

### TECHNICAL FIELD

The disclosure relates to terminal and mobile devices, and more specifically, to a device locking method and apparatus.

### BACKGROUND

Personal user devices also known as mobile devices, for example smartphones, tablets, and laptops, are part of daily life. Such devices are portable and use battery power, for example, lithium-ion batteries. The devices allow users access to information and provide user interface through display screens, for example, (LCD) or organic light-emitting diode (OLED) based screens. Some display screens provide a touchscreen interface. Mobile devices provide users, via the user interface, with a number of features and capabilities. The devices can connect to the Internet and interconnect with other devices (e.g., headsets, peripheral devices) using wireless technology, such as Wi-Fi, Bluetooth, cellular networks or near field communication (NFC). The devices can also provide various utilities, including integrated cameras, the ability to place and receive voice and video telephone calls, video games, and Global Positioning System (GPS) capabilities. Mobile devices run mobile operating systems that allow applications for using device capabilities and software utilities. The applications are computer programs or instructions that, when executed by the device, perform intended functions.

### SUMMARY

The disclosure provides a method, system and apparatus for locking a user device, such as mobile device, from access or use. The locking prevents access to device capabilities in term of hardware features and to device software functions and utilities.

In accordance with at least one embodiment of the disclosure, a method for implementing lock control of hardware and software features in a device includes authorizing, using a menu displayed on the device, a customer for implementing lock control on the device for a group of users, blocking the group of users from accessing each system feature switched off by the customer, and blocking the group of users from accessing each application switched off by the customer. The device may be a mobile device, such as a mobile phone, a smartphone, or a tablet.

In accordance with another embodiment of the disclosure, an electronic device includes a processor and a memory coupled to the processor and configured to store a computer program, comprising instructions when executed by the processor cause the processor to be configured to display a first menu for lock control, where the first menu comprises a first option for selecting a second menu of system features and a second option for selecting a third menu of applications. The instructions further cause the processor to perform one of select the first option to display the second menu and switch off a system feature in the second menu, where the switching off blocks the system feature from access, or select the second option to display the third menu and switch off an application in the second menu, where the switching off blocks the application from access.

In accordance with another embodiment of the disclosure, a computer program product comprising computer-executable instructions is stored on a non-transitory computer-readable medium. When executed by a processor, the computer program product causes a device to display, on a display screen, a first menu for lock control, where the first menu comprises a first option for selecting a second menu of system features and a second option for selecting a third menu of applications. The computer program product further causes the non-transitory computer-readable medium to switch off a system feature in the second menu when selecting the first option, where the switching off blocks the system feature from access, and switch off an application in the second menu when selecting the second option, where the switching off blocks the application from access.

These and other features will be more clearly understood from the following detailed description taken in conjunction with the accompanying drawings and claims.

### BRIEF DESCRIPTION OF DRAWINGS

For a more complete understanding of the present disclosure, reference is now made to the following brief description, taken in connection with the accompanying drawings and detailed description, wherein like reference numerals represent like parts.

FIG. 1 is a schematic diagram of a mobile device, in accordance with an embodiment of the disclosure.

FIG. 2 is a schematic structural diagram of a mobile device, in accordance with an embodiment of the disclosure.

FIG. 3 is a flow diagram of a lock control process, in accordance with an embodiment of the disclosure.

FIGS. 4A to 4J illustrate various views displayed on a mobile device, in accordance with an embodiment of the disclosure.

FIG. 5 is a flow diagram of a lock control method, in accordance with an embodiment of the disclosure.

### DESCRIPTION OF EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The disclosure provides a method, system and apparatus for locking selected features of a personal or mobile device, such as smartphone or tablet features. Locking the device may include preventing access to one or more software or hardware features of the device. For example, a hardware feature, such as access to the device's integrated camera or wireless connection capability, may be locked to a group of users. A group of users may include one or more users intended to receive and operate the device. Similarly, software features, such as one or more applications on the device may be locked. The locking of features can provide a level of customization of the device for intended group of users. Thus, when the group of users receive the device, the users are prevented from accessing and using the blocked device features.

The features can be locked for an intended group of users or customers according to group restrictions of use. Various features of the device, such as system device features or application features, can be locked from access to configure the device for specific use according to requirements for a group of users. As such, the same device can be sold or provided to various groups of users and configured differently for each group according to the requirements or restrictions of use for the group. For example, the same device, e.g., a cell phone, can be configured differently for two different groups of customers, where a first group can access the camera features of the device and the second group does not have such access. Another example is locking the device Wi-Fi or Bluetooth connectivity feature for a particular group of customers, while allowing other groups of customers to use this feature.

In embodiments, the method and apparatus of locking the device features can be implemented in the form of steps of menu options displayed on the device screen. A user, such as an administrator managing the locking of features of the device, can use a series of menus to select which features to allow and which features to block from access to any particular group of users. The group of users may include people within an organization (i.e., employees of a business) or members of any other group, such as family members. Typically, one person in the group of users (i.e., a business leader or parent) will purchase the mobile device and implement the lock control on behalf of other users in the group.

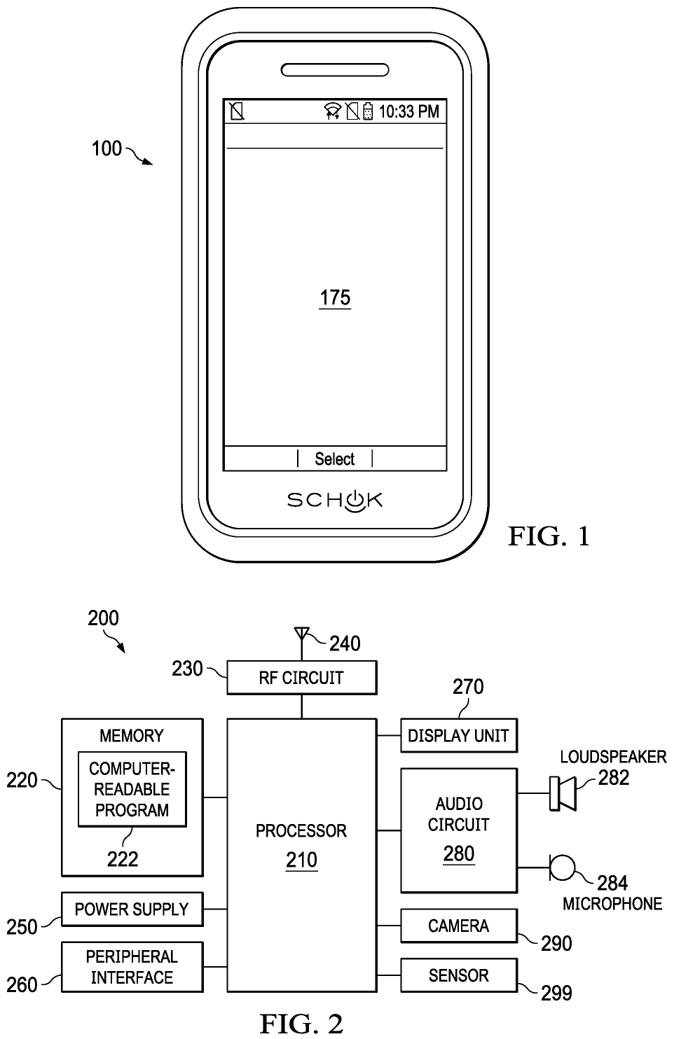

The methods provided in this application may be performed by a device with a display screen. The device may be a mobile phone 100 as shown in FIG. 1. The mobile phone 100 includes display screen 170 for displaying visual output. The display screen may also be a touchscreen capable of obtaining user input though touch gestures. Alternatively, the device may be a tablet computer, a personal computer (PC), a personal digital assistant (PDA), a smartwatch, a netbook, a wearable electronic device, an augmented reality (AR) device, a virtual reality (VR) device, or other personal or mobile devices. This disclosure imposes no special limitations on a specific form or type of the device.

FIG. 2 is a schematic structural diagram showing at least some of the components of a mobile device 200, in accordance with an embodiment of the disclosure. For instance, the mobile device 200 may correspond to the mobile phone 100 and the components of the mobile device 200 may be prat of the mobile phone 100. Alternatively, the mobile device 200 may correspond to a tablet computer, a PC, a PDA, a smartwatch, a netbook, a wearable electronic device, an AR device, a VR device, or other personal or mobile devices. As shown in FIG. 2, the mobile device 200 includes a processor 210, a memory 230, a radio frequency (RF) circuit 230, an antenna 240, a power apparatus 250, a peripheral interface 260, a display unit 270 including a touchscreen, an audio circuit 280, a camera 290, and one or more sensors 299. The mobile device 200 may also include a Bluetooth apparatus, a Wi-Fi apparatus, and a positioning apparatus (e.g., a global positioning system (GPS)). In various embodiments, the mobile device may include more or fewer components, or may combine some components, or may have different component arrangements.

The processor 210 may be configured to control the RF circuit 230 and the antenna 340 to send and receive a signal. The processor 210 may invoke the computer program 222 from the memory 220, and run the computer program 222 to perform a corresponding procedure, such as instructions or steps performed by a mobile device for implementing lock control of hardware and software features in the device. The processor 210 is a control center of the device that connects to various components of the device by using various interfaces and bus lines. In embodiments, the processor 210 may include one or more processing units. The processor 210 may also include facial recognition and/or a fingerprint verification chip used to verify the user.

The memory 220 may be configured to store the computer program 222 (e.g., an application) and data, and the processor 210 may perform various functions and data processing of the device by running the computer program 222 and the data stored in the memory 220. The memory 220 can include a program storage area and a data storage area. The program storage area may store an operating system, and an application program required by at least one function (e.g., an audio play function or an image play function). The data storage area may store data (e.g., audio data and a phone book) created based on use of the device. In addition, the memory 220 may include a high-speed random-access memory (RAM), and may also include a nonvolatile memory such as a magnetic disk storage device, a flash memory device, or another volatile solid-state storage device. The memory 220 may store various operating systems, such as an iOS® operating system developed by Apple Inc., and/or an Android® operating system developed by GOOGLE Inc. The memory 220 may exist separately, and is connected to the processor 210 by using a communications bus. Alternatively, the memory 220 may be integrated with the processor 210. The memory 220 may also be referred to as a storage medium, a storage device, or the like. Although FIG. 2 shows one processor 210 and one memory 220, an actual mobile device may have a plurality of processors and a plurality of memories. This is not limited in the embodiments of this disclosure.

The RF circuit 230 may be configured to receive and send wireless signals during a call or information reception or sending. The RF circuit 230 may send received data to the processor 210 for processing, and in addition, send out data to a network or another device. Generally, the RF circuit 230 includes but is not limited to the antenna 240, at least one amplifier, a transceiver, a coupler, a low noise amplifier, a duplexer, and the like. In addition, the RF circuit 230 may also communicate with another device, e.g., through wireless communication. The wireless communication may use any communication standard or protocol, including but not limited to Global System for Mobile Communications (GSM), General Packet Radio Service (GPRS), Code Division Multiple Access (CDMA), Wideband CDMA, Long Term Evolution (LTE), Email, Short Message Service (SMS), and the like.

The mobile device 200 may further include the power apparatus 250, such as an externa power source or a battery and a power management chip, that supplies power to each component. The battery may be logically connected to the processor 210 by using the power management chip, so as to implement functions such as charge management, discharge management, and power consumption management by using the power apparatus 250.

The peripheral interface 260 may be configured to provide various interfaces for external input/output devices (such as a keyboard, a mouse, an external display, an external memory, and a subscriber identification module card). For example, the peripheral interface 260 is connected to the mouse through a universal serial bus (USB) interface, and is connected to a subscriber identification module (SIM) card provided by a telecom operator through a metal contact on a card slot of the subscriber identification module. The peripheral interface 260 may be configured to couple the external input/output devices to the processor 210 and the memory 220. The mobile device 200 may communicate with another device in a device group through the peripheral interface 260. For example, the mobile device 200 may receive, through the peripheral interface 260, display data sent by another device for display. This is not limited in the embodiments of this disclosure.

The display unit 270 may include a touch panel and a display, jointly referred to as a touchscreen. The touch panel may collect a touch event, such as an operation performed by a user on or near the touch panel using any proper object such as a finger or a stylus, and send collected touch information to another component of the device, for example, the processor 210. The touch event performed by the user near the touch panel may be referred to as a floating touch. The floating touch may mean that the user does not need to directly touch the touch panel to select, move, or drag a target (e.g., an icon on the touchscreen), and the user only needs to stay near the device to perform a desired function. In addition, the touch panel may be implemented by using a plurality of types, such as a resistive type, a capacitive type, an infrared type, and a surface acoustic wave type.

The display (also known as a display screen) may be configured to display information input by the user, or information provided to the user, and various menus of the device. The display may be configured in a form of a liquid crystal display, an organic light-emitting diode, or the like. The touch panel may cover the display. After detecting the touch event on or near the touch panel, the touch panel sends the touch event to the processor 210 to determine a touch event type, and then the processor 210 may provide corresponding visual output on the display based on the touch event type. The touch panel and the display screen can be used as two independent components to implement input and output functions of the device. However, in some embodiments, the touch panel and the display screen may be integrated to implement the input and output functions of the device. It may be understood that the touchscreen is formed by stacking a plurality of layers of materials. The touch panel may be configured in a full-panel form on a front surface of the device, and the display screen may also be configured in a full-panel form on the front surface of the device, so that a bezel-free structure can be obtained on the front surface of the device.

In addition, the mobile device 200 may further have a fingerprint recognition function. For example, a fingerprint reader may be configured on a back surface of the device (e.g., below a rear camera), or a fingerprint reader may be configured on the front surface of the device (e.g., below the touchscreen). For another example, a fingerprint collection device may be configured in the touchscreen to implement the fingerprint recognition function. In other words, the fingerprint collection device may be integrated with the touchscreen to implement the fingerprint recognition function of the device. In this case, the fingerprint collection device is configured in the touchscreen, and may be a part of the touchscreen, or may be configured in the touchscreen in another manner. A main component of the fingerprint collection device is a fingerprint sensor, and the fingerprint sensor may use any type of sensing technology, including but not limited to an optical type, a capacitive type, a piezoelectric type, or an ultrasonic sensing technology.

The audio circuit 280, the loudspeaker 282, and/or the microphone 284 may provide an audio interface between the user and the mobile device 200. The audio circuit 280 may transmit an electrical signal converted from received audio data to the loudspeaker 282, and the loudspeaker 282 converts the electrical signal into an audio signal for outputting. In addition, the microphone 284 converts a collected audio signal into an electrical signal, and the audio circuit 280 receives the electrical signal, converts the electrical signal into audio data, and then outputs the audio data to the RF circuit 230, so that the audio data is sent to, for example, another device, or the audio data is output to the memory 220 for further processing.

The mobile device 200 may include a camera 290 (e.g., a front camera and/or a rear camera), a flash, a micro projection apparatus, a near field communication (NFC) apparatus, and the like. The mobile device 200 may also include at least one sensor 299, such as a light sensor, a motion sensor, or another sensor. The light sensor may include an ambient light sensor and a proximity sensor. The ambient light sensor may adjust luminance of the display of the touchscreen based on brightness of ambient light. The proximity sensor may turn off the display when the device moves to an ear. As one type of motion sensor, an accelerometer sensor may detect an acceleration magnitude in various directions (usually on three axes), may detect a magnitude and a direction of gravity when the device (e.g., a mobile phone) is in a static state, and may be applied to an application that recognizes a device posture (such as screen switching between a landscape mode and a portrait mode, a related game, and magnetometer posture calibration), a vibration recognition-related function (such as a pedometer or tapping), and the like. Other sensors may also be included in the device, such as a gyroscope, a barometer, a hygrometer, a thermometer, or an infrared sensor.

The mobile device 200 may further include a Bluetooth apparatus that is configured to realize data exchange between the device and another device (e.g., a mobile phone or a smartwatch) in a short distance. The Bluetooth apparatus may be an integrated circuit, a Bluetooth chip, or the like. The mobile device 200 may include a Wi-Fi apparatus configured to provide the device with a network access that complies with Wi-Fi related standard protocols. The device may be connected to a Wi-Fi access point by using the Wi-Fi apparatus, to help the user send or receive an email, browse a webpage, access streaming media, and the like. The Wi-Fi apparatus provides the user with wireless broadband Internet access. In embodiments, the Wi-Fi apparatus may also function as a Wi-Fi wireless access point to provide Wi-Fi network access for another device.

The mobile device 200 may further include a positioning apparatus. The positioning apparatus is configured to provide a geographic location for the device. It can be understood that the positioning apparatus may be a receiver of a positioning system such as a GPS. After receiving the geographic location sent by the foregoing positioning system, the positioning apparatus sends the information to the processor 210 for processing, or sends the information to the memory 220 for storage. In some other embodiments, the positioning apparatus may be a receiver of an assisted global positioning system (AGPS). The AGPS system acts as an assistance server to assist the positioning apparatus in performing ranging and positioning services. In this case, the assistance positioning server communicates with a device such as the positioning apparatus (e.g., the GPS receiver) of the device through a wireless communications network to provide positioning assistance. In some embodiments, the positioning apparatus may alternatively use a positioning technology that is based on a Wi-Fi access point. Each Wi-Fi access point has a globally unique media access control (MAC) address. When Wi-Fi is enabled on the device, the device can scan and collect broadcast signals from surrounding Wi-Fi access points, to obtain MAC addresses broadcast by the Wi-Fi access points. The device sends, to a location server by using a wireless communications network, data (such as the MAC address) that can indicate the Wi-Fi access points. The location server retrieves geographic locations of the Wi-Fi access points, calculates a geographic location of the device based on strength of Wi-Fi broadcast signals, and sends the geographic location to the positioning apparatus of the device.

The lock control method disclosed herein may be implemented by a software program or an application installed on the mobile device 200. As described above, the software may be instructions of the computer program 222 stored in the memory 220 and executed by the processor 210. An icon of the application program may be displayed on the display of the device. The software or application may have access restricted to users having the authorization to configure the device for locking features, such as administrators in charge of blocking or granting access of device features to intended groups of users. Device features can include system features or hardware features, for example any of the functionality features of the components of the device described above. The device features also include application features related to software executable on the device including applications pre-installed on the device or applications that can be downloaded on the device.

The method, apparatus and system provided herein can be used to address a problem or need in current consumer applications. For instance, in current markets, a mobile device (e.g., a tablet or smartphone) may need to meet the requirements of certain segments of consumer groups, such as phones and tablets made for use by children, where certain features of the device need to be blocked or disabled. For example, children phones may require blocking internet access. A religious purpose driven device may not be allowed to use certain features, such as video, messages, cameras, or applications not installed on the device. Government guidelines may also require blocking cameras or video use in sensitive areas. Schools may have clear mandate on school devices to restrict or prohibit installing any external applications. Typically, devices configured for such groups of users come from the factory preconfigured for these specific segments of users or customers, creating a device that cannot change unless there is a specific firmware update to unblock the device or its features. These devices may serve only the particular purpose of the intended group, which can create a higher price to the consumer as it would be produced with smaller economies of scale. This can also limit the sale of the used device back to consumer markets as the device is made for a specific segment, creating more electronic waste even though the device may still be suitable for use, for example in countries of economic need.

The method, apparatus and system of this disclosure can address such issues by allowing the configuration of the same device for different segments of society or groups of users without needing a factory configuration before delivering the device to market and without the need for a firmware update. Instead of creating a device that will fit a particular segment, the method, apparatus and system herein allow control of device features, related to both hardware and software, in any personal or mobile device such as a basic cell phone, a smartphone or a tablet. Specifically, this is achieved using a menu displaying available features of the device as well as available applications. The menu allows controlling the access of such features with simple intuitive on/off switches.

A menu control approach, referred to herein as lock control, can be implemented as software on the device, for instance as a device application. A lock control design can be preinstalled on the device or optionally can be downloaded. Specifically, access of the lock control application is secured to a specific user who has authorization to control which features of the device are allowed or blocked for a group of users. The authorized user may be an administrator of the group or any customer authorized to configure the device for restricted feature access according to requirements of a segment of users. The lock control application can be secured via a password or any other means of securing access on the device, such as using fingerprint verification, face recognition, voice recognition, a touch pattern on the touchscreen, or combinations thereof. For instance, the feature may be unlocked by an authorized user upon a successful user verification. This may include entering verification credentials, for example user identification or password, or entering a preset pattern on the device, for example using the touchscreen. The device may also be unlocked using biometric authentication, for example using facial recognition or fingerprint.

The lock control method is used to configure the device by blocking features of the device for intended users and preventing the users from making any modification to the restricted access configuration, therefore forcing the users to use the device as intended for their group. The restricted access configuration can be set by the customer who accesses the lock control application and who is in charge of the group, such as an administrator of an organization that restricts its users from using certain features of the device. Further, the device lock configuration can be removed by the customer when device features are no longer needed to be blocked. The customer can simply switch back each of the features that were turned off and the device will be configured for normal operation without any features blocked. Similarly, the customer can change the configuration when desired by changing which features are switched on or off. As such, the device features can be reconfigured as many times as needed without the need for firmware updates or factory resetting.

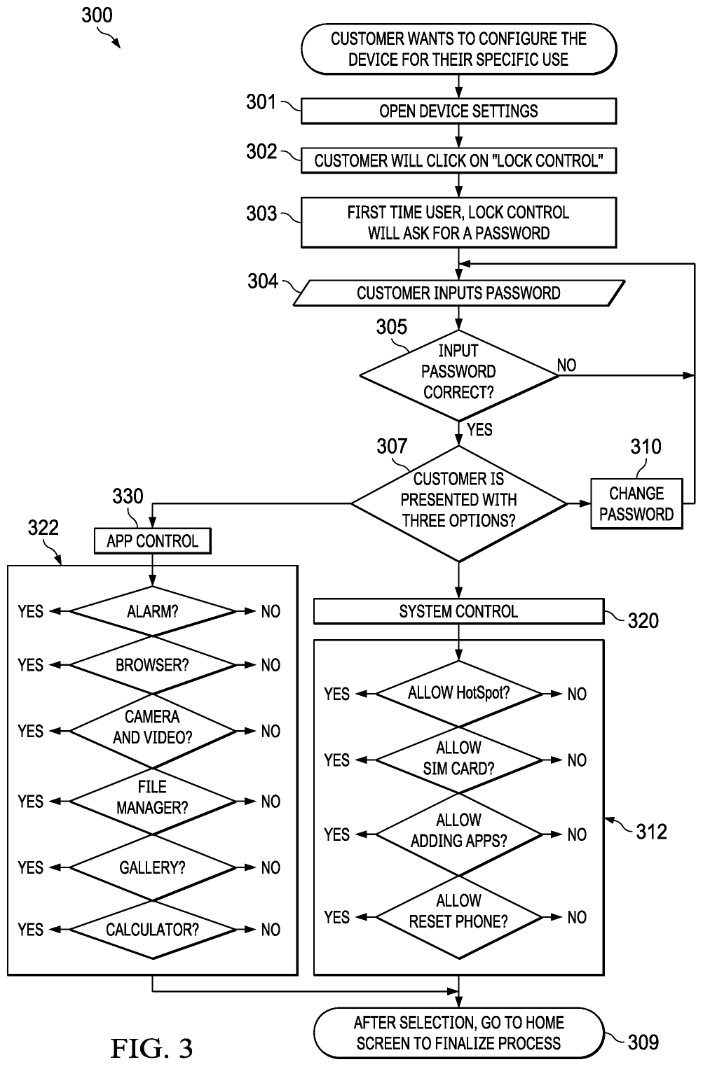

FIG. 3 illustrates a flowchart of an embodiment of a lock control process 300 according to the disclosure. The lock control process may be performed by any mobile device configured to implement the lock control method above, such as the mobile phone 100 or the mobile device 200. As described above, the lock control process 300 can be implemented using a software or application on the device. The process can be implemented when a customer needs to grant certain or restricted access to the device for a user or a group of users, for example, according to the requirements or restrictions of use for the group. For instance, a parent may want to restrict or block internet or video access on the device to younger members of the family. In another example, a group manager may need to block video and audio features on the device before allowing one or more employees to use the device. Initially, the customer opens the device settings in a step 301. The authorized customer may be any customer that obtains authorization credentials, for example a password, to access the lock control application. Alternatively, the customer may be a first user that accesses the lock control application and set up a password to restrict access to the lock control application, as described below. In this example, the device settings can be accessed on the device as part of the built-in device settings, such as in the settings application of the operating system of the device. In other embodiments, the lock control software may be downloadable or preinstalled with other applications on the device. In step 302, the customer selects the “lock control” option in the settings menu. As a first time user, the customer is prompted, in step 303, to enter a password in order to verify that the customer is authorized to use the lock control application. When the customer inputs his authorization password (step 304), the process verifies if the password is correct in step 305. If the password matches a prestored password for authorized customers, the process proceeds to the remaining steps. Otherwise, the customer is asked to reenter a password for verification. This can be repeated a predetermined amount of times until a correct password is entered or the process is aborted, for example when a preset maximum number of allowed attempts is reached. As described above, user verification can be implemented via any means of user authentication available on the device. This can be entering a password, or in other embodiments, scanning a fingerprint, a facial recognition process, or any other user verification means supported on the device.

After authorizing the customer, a plurality of available options may be displayed in step 307. This may include an option to change the password (option 310), a system control option (option 320), and an option for application control (step 330). The options may be presented in the form of a menu of options. Selecting the password change option 310 prompts the user to enter a new password to be used for next time accessing lock control. Selecting the system control option 320 provides the user with a list 312 of available device system features that can be switched on or off. For instance, a list of features is displayed with corresponding slide buttons (or radio buttons in another example) that can be selected by the customer to allow or lock features as required according to group access restrictions. For example, the customer can decide whether to allow or block the group from using a Wi-Fi Hotspot, using a SIM card, adding an application to the device, and resetting the device to factory settings or a prior date. Other system control options may be included in this list. Switching the system feature off may render the feature invisible to the intended group of users. Selecting the application control option 330 provides the user with a list 322 of available applications on the device that can be switched on or off. For example, the customer can decide whether to allow or block the alarm application, the browser application, the camera and video application, the file manager application, the photo gallery application, the calculator application, or other applications on the device. Other application control options may be included in this list. The list of applications may be updated according to current applications available on the device. For example, the list 322 of available applications may be updated to reflect any newly downloaded applications or deleted application. A newly downloaded application may be added to the list 322 after the downloading, and any deleted application previously presented in the list 322 may be removed from the list 322 after deleting the application. Switching such applications off may render the applications invisible to the intended group of users. In step 309, the process is finalized by returning a home screen of the device after performing a selection by the user.

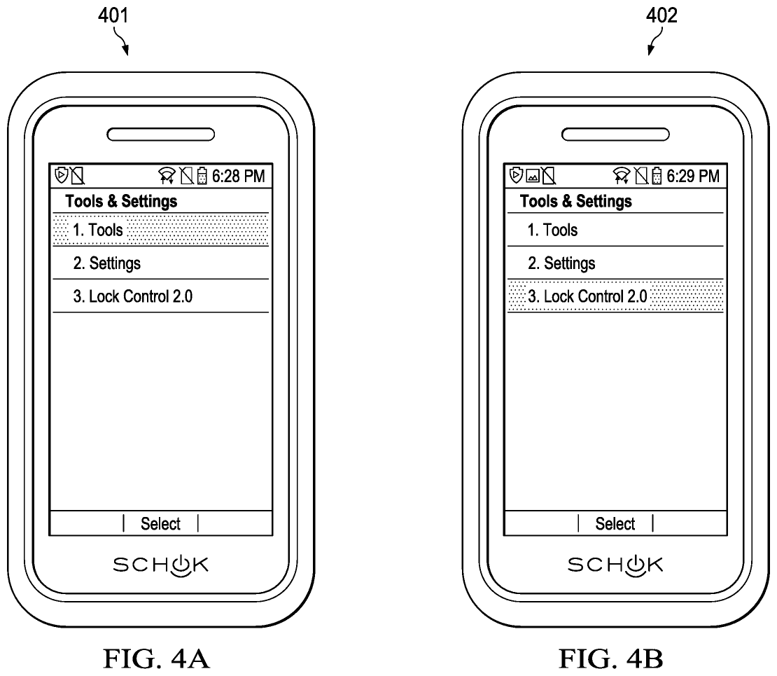

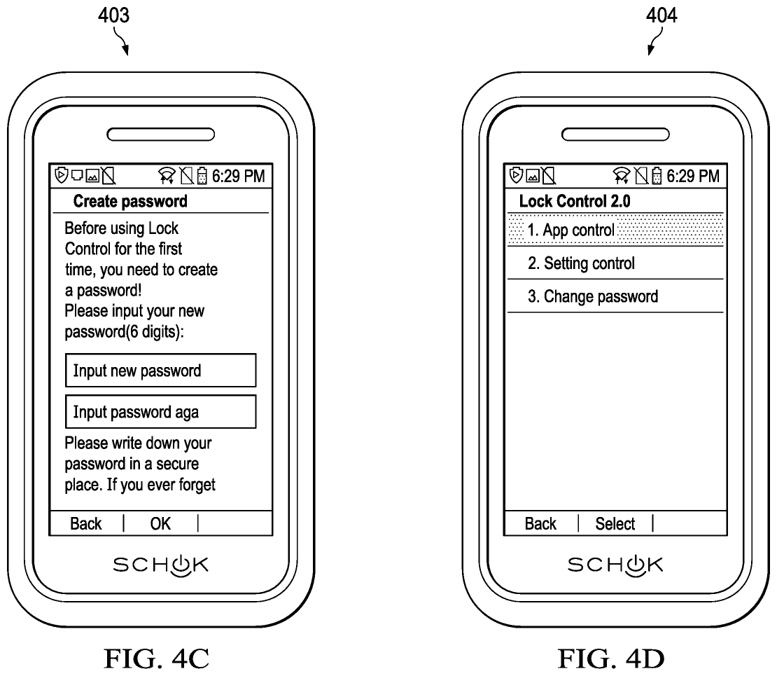

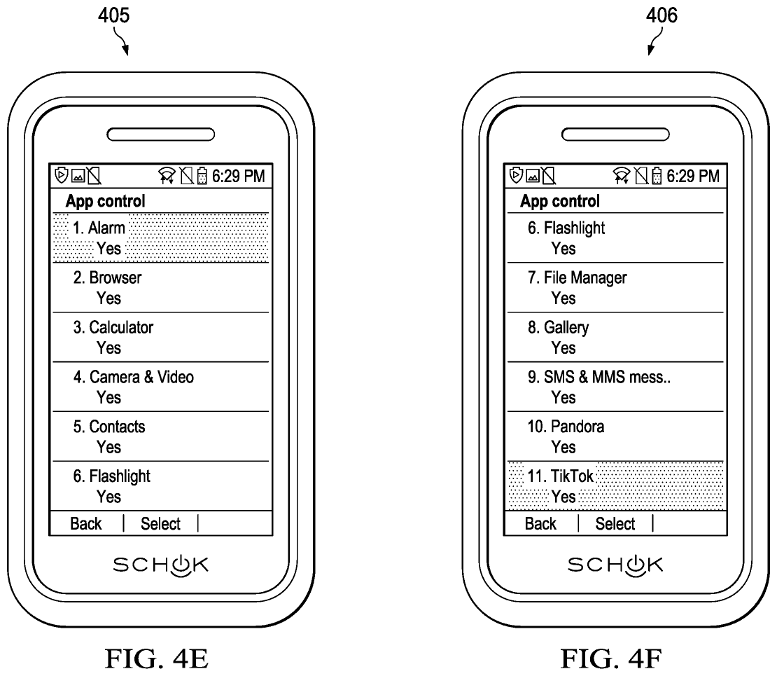

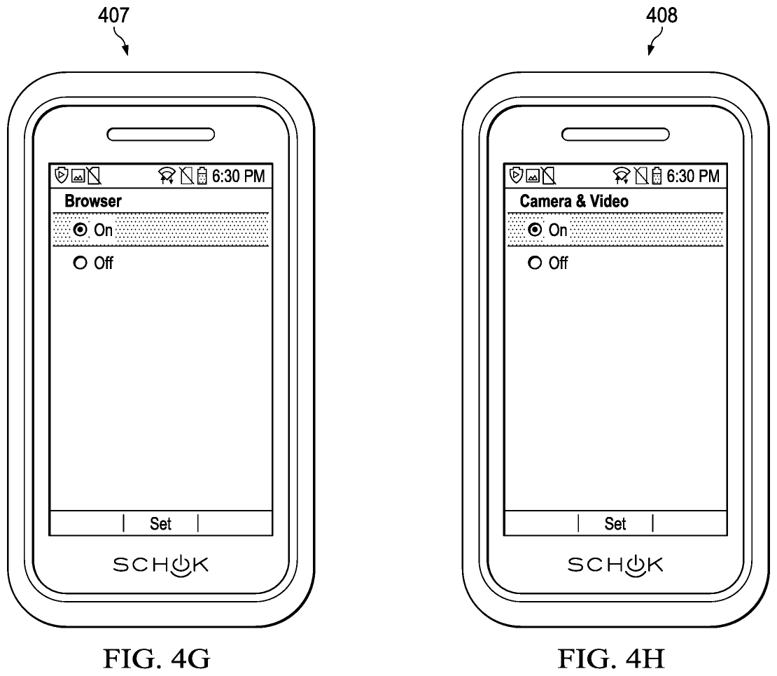

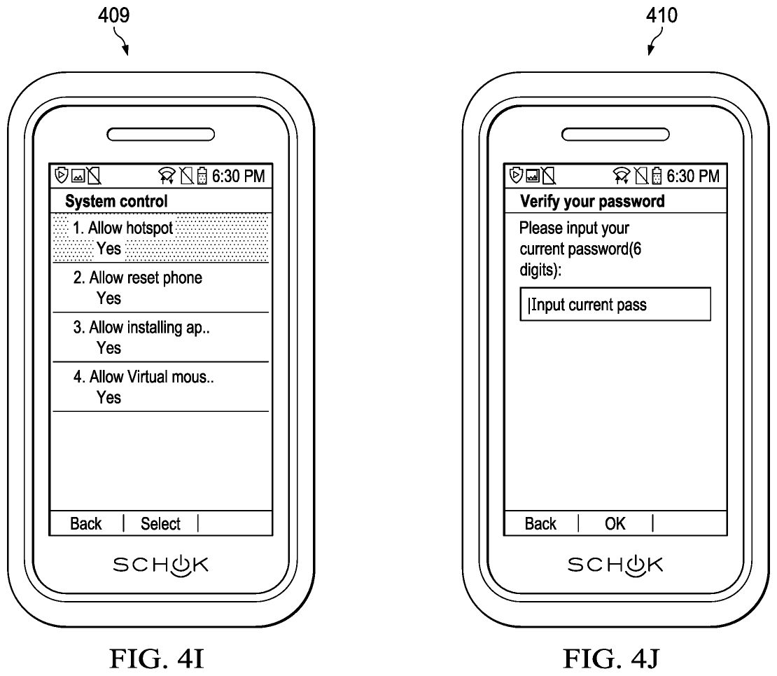

FIGS. 4A to 4J illustrate an implementation of the process 300 above on a mobile phone. The steps of the process above are shown in a series of screen views 401 to 410 showing the menu options throughout the steps of lock control as carried by the customer. For instance, when selecting the “Tools and Settings” option of the device, e.g. in step 301 of the process 300, the device displays, as shown in screen view 401, a menu of options including a “Lock Control” option. The customer can then select the “Lock Control” option, e.g., in step 302, to switch to screen view 402. When the customer selects the “Lock Control” option for the first time, a “Create Password” window is displayed, as shown in screen view 403, allowing the customer to enter and confirm a password, and preventing unauthorized users from using lock control to unblock features on the device. As described in steps 303-305 of the process 300, the “Create Password” window may be displayed the first time the customer accesses the “Lock Control” option to allow the customer, such as an administrator of a group of users, to set up a desired password. A similar “Change Password” window can be displayed when the authorized customer selects a change password option (e.g., option 310).

As described in step 307, after setting up a password, a “Lock Control” window is displayed, in screen view 404, showing multiple options as described above (options 310, 320 and 330). When the customer selects the “App Control” option, a list of applications (similar to list 322) is displaced, in screen view 405, showing which applications are switched on or off on the device. By default, all applications may be switched on (e.g., indicated by “Yes”) the first time the customer uses lock control. The customer can go through the list and determine which of the applications to switch off for the group of users, leaving the remaining applications switched on. To switch an application off, the customer selects an application, for example the “TikTok” application highlighted in screen view 406. The selection displays a corresponding application window, for example as shown in screen view 407 for a “Browser” application, with the option of switching the application on or off. In one example, the switching option may be selected using radio buttons. Another example shown in screen view 408, the customer may switch the camera and video application on to unlock access to this application.

Similarly, when the customer selects the “System Control” option, a list of device system features (similar to list 312) is displayed. As shown in screen view 409, the list indicates which device features are switched on or off. By default, all device system features may be switched on (or off) the first time the customer uses lock control. The customer can go through the list and determine which of the system features to switch off for the group of users, leaving the remaining features switched on. When a feature is selected, as highlighted in screen view 409, a corresponding window may be displayed to allow the customer to switch the device off or on (not shown). When the “Lock Control” option is accessed a second time after the initial access by the authorized customer, a “Verify Password” window is displayed. As shown in screen view 410, the window prompts a user to enter a password to authenticate the user as the authorized customer. This prevents a user of the device other than the authorized customer from changing the lock control settings determined by the authorized customer. However, the authorized customer can access lock control at any time by entering his or her initially entered password during the first access of the “Lock Control” menu.

The lock control system and process described herein can be installed on the device by the original equipment manufacturer (OEM) or as an aftermarket add-on. In addition, the lock control system described herein may be the only lock control system on the device, or may exist in conjunction with at least one other lock control system (e.g., a screen lock system).

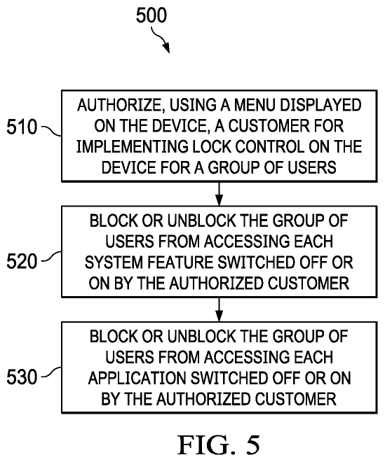

FIG. 5 is a flow diagram of a lock control method 500, in accordance with an embodiment of the disclosure. The lock control method 500 may be implemented on a mobile device, for example the mobile phone 100 or the mobile device 200, to enable a customer to grant or restrict a user or a group of users from accessing system features or applications on the device. The method 500 may comprise at least some of the steps of the process 300, or similar steps, presented to the customer through a plurality of displayed user interfaces and menus, as shown in FIGS. 4A to 4J. At a first step 510, a customer is first authorized for using lock control on the device. A menu may be displayed for entering user verification information, for example a password. The password may be made known to an authorized customer by the manufacturer or the device provider, for example, a cellular service carrier or a distributer of the device. Alternatively, the password may be set by the customer upon first use of the lock control application. The authorized customer may thus decide to lock or unlock the features to a group of users. At step 520, the group of users are blocked or unblocked from accessing each system feature switched off or on, respectively, by the authorized customer. The system features may be allowed to users by default unless switched off by the authorized customer. The authorized customer may unblock a group of users from accessing a system feature by switching on the system feature in the lock control menu, as described above. At step 530, the group of users are blocked or unblocked from accessing each application switched off or on, respectively, by the authorized customer. As in the case of system features, applications may be allowed to users by default unless switched off by the authorized customer. The authorized customer may unblock a group of users from accessing an application by switching on the system feature in the lock control menu. The authorized customer may reconfigure access to system features and applications on the mobile device when needed. For example, a feature or an application unblocked to a group of users may be blocked again by switching off the access on the device.

While several embodiments have been provided in the present disclosure, it should be understood that the disclosed systems and methods might be embodied in other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, methods and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

In the embodiments of this disclosure, “at least one” means one or more, and “a plurality of” means two or more. “At least one of the following items” or a similar expression thereof indicates any combination of these items, including a single item or any combination of a plurality of items. For example, at least one item of a, b, or c may represent: a, b, c, a-b, a-c, b-c, or a-b-c, where a, b, and c may be singular or plural.

A person of ordinary skill in the art may be aware that the units and algorithm steps described in the embodiments disclosed in this specification may be implemented by a combination of electronic hardware, computer software, and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

In a plurality of embodiments provided in this disclosure, the disclosed system, apparatus and method may be implemented in other manners. For example, the described apparatus embodiments are merely examples. For example, the module division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected based on actual requirements to achieve the objectives of the solutions of this application.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this disclosure essentially, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of this application. The foregoing storage medium includes any medium that can store program code, for example, a USB flash drive, a removable hard disk, a ROM device, a RAM device, a magnetic disk, or an optical disc.

The foregoing descriptions are merely specific implementations of this disclosure. Any variation or replacement readily figured out by a person skilled in the art within the technical scope disclosed in this disclosure shall fall within the protection scope of this disclosure. The protection scope of this disclosure shall be subject to the protection scope of the claims.

What is claimed is:

1. A method for lock control of hardware and software features in a device includes:
authorizing, using a menu for lock control displayed on the device, a customer for implementing lock control on the device for a group of users;
blocking the group of users from accessing each system feature switched off by the customer; and
blocking the group of users from accessing each application switched off by the customer.

2. The method of claim 1, further comprising switching on the system feature, wherein the switching on allows the group of users access to the system feature.

3. The method of claim 1, further comprising switching on the application, wherein the switching on allows the group of users to use the application.

4. The method for claim 1, further comprising:
entering, by the customer, a password before entering the menu for lock control for a first time;
storing the password to restrict access to the menu; and
enabling the customer to enter the menu for lock control for a next time after entering the password.

5. The method of claim 1, further comprising
displaying a menu for device settings including an option for selecting the menu for lock control; and
displaying the menu for lock control when selecting the option.

6. The method of claim 5, wherein the menu for lock control comprises a first option for selecting a first list of system features and a second option for selecting a second list of applications.

7. The method of claim 6, further comprising:
displaying the first list when selecting the first option; or
displaying the second list when selecting the second option.

8. The method of claim 7, further comprising:
switching the system feature off or on in the first list; or
switching the application off or on in the second list.

9. The method of claim 5, wherein the menu for lock control comprises a third option for changing a password for accessing the menu for lock control.

10. The method of claim 1, wherein switching the system feature off renders the system feature invisible on the device, or wherein switching the application off renders the application invisible on the device.

11. The method for claim 1, further comprising opening an application on the device for displaying the menu for lock control.

12. The method for claim 1, wherein the system feature and the application are switch off and switch on using sliding or radio buttons.

13. An electronic device, comprising:
a processor;
a memory coupled to the processor and configured to store a computer program, wherein the computer program comprises instructions that, when executed by the processor, cause the processor to be configured to:
display a first menu for lock control, wherein the first menu comprises a first option for selecting a second menu of system features and a second option for selecting a third menu of applications; and
perform one of:
select the first option to display the second menu and switch off a system feature in the second menu, wherein the switching off blocks the system feature from access; or
select the second option to display the third menu and switch off an application in the second menu, wherein the switching off blocks the application from access.

14. The electronic device of claim 13, wherein the first menu comprises a third option for changing a password for accessing the first menu for lock control, and wherein the instructions further cause the processor to be configured to:
read a password entered by a user when selecting the third option; and
restrict access to the first menu with the password.

15. The electronic device of claim 13, wherein the instructions further cause the processor to be configured to:
read a password entered by a user before displaying the first menu;
save the password to restrict access to the first menu; and
enable access to the first menu after entering the password.

16. The electronic device of claim 13, wherein the instructions further cause the processor to be configured to perform one of:
select the first option to display the second menu and switch on a system feature in the second menu, wherein the switching on allows access to the system feature; or
select the second option to display the third menu and switch on an application in the second menu, wherein the switching on allows access to the application.

17. The electronic device of claim 13, wherein the system feature is a hardware function supported by the electronic device.

18. The electronic device of claim 13, wherein the electronic device is a smartphone, a tablet, a laptop, or other mobile device.

19. A computer program product comprising computer-executable instructions stored on a non-transitory computer-readable medium that, when executed by a processor, cause a device to:
display, on a display screen, a first menu for lock control, wherein the first menu comprises a first option for selecting a second menu of system features and a second option for selecting a third menu of applications;
switch off a system feature in the second menu when selecting the first option, wherein the switching off blocks the system feature from access; and
switch off an application in the second menu when selecting the second option, wherein the switching off blocks the application from access.

20. The computer program product of claim 19, wherein the computer-executable instructions further cause the device to:
display a fourth menu for device settings, wherein the fourth menu comprises a third option for selecting the first menu for lock control; and
display the first menu when selecting the third option.
